(19) United States
(12) Patent Application Publication
(10) Pub. No.: US 2018/0113683 A1
(43) Pub. Date: Apr. 26, 2018

(54) VIRTUAL INTERACTIVE LEARNING ENVIRONMENT

(71) Applicant: Modest Tree Media Inc., Halifax (CA)

(72) Inventors: Saman SANNANDEJI, Halifax (CA); Steven VERMEULEN, Halifax (CA)

(21) Appl. No.: 15/843,491

(22) Filed: Dec. 15, 2017

Related U.S. Application Data
(63) Continuation of application No. 14/698,075, filed on Apr. 28, 2015, now abandoned.
(60) Provisional application No. 61/985,054, filed on Apr. 28, 2014.

(51) Int. Cl. G06F 8/34

(52) U.S. Cl. CPC G06F 8/34

(57) ABSTRACT

Methods, systems and computer readable mediums for designing a virtual interactive learning environment. A model defining visuospatial parameters of a simulated environment is read from memory. The simulated environment, comprising scene object(s), is rendered for display within a Graphical User Interface (GUI). The scene object(s) comprise at least one interactive scene object. Using the GUI, an interactive node is associated with the interactive scene object and defines an interactive action for activation. An action node associated with the scene object is defined using the GUI, for affecting a visuospatial representation of at least one of the scene object(s) following activation of the interactive node. The rendered simulated environment may be re-rendered during the designing of the virtual learning environment when the action node is defined.

### PRIORITY STATEMENT

This non-provisional patent application is a continuation from U.S. patent application entitled “VIRTUAL INTERACTIVE LEARNING ENVIRONMENT”, application Ser. No. 14/698,075, filed Apr. 28, 2015, in the name of Modest Tree Inc., which is incorporated by reference herein in its entirety and which claims priority based upon the prior U.S. provisional patent application entitled “INTERACTIVE LEARNING ENVIRONMENT”, application No. 61/985,054, filed Apr. 28, 2014, in the name of Modest Tree Inc., which is also incorporated by reference herein in its entirety.

### TECHNICAL FIELD

The present invention relates to a computer simulated environment and, more specifically, to a customizable computer simulated environment.

### BACKGROUND

In some cases, training to acquire the necessary skills to operate complex systems is performed in a computer simulated environment. This is particularly relevant when costs and risks associated with operating a live system are too high to accommodate trainees. In these instances, the time, money and effort necessary for the development of a dedicated computer simulated training environment may be justified.

The cost and complexity associated with the development of such computer simulated environments are high.

There is a need to develop computer simulated environments that could be used to perform training for customized tasks. Such a customizable computer simulated environment may further be used for purposes other than training. The present invention addresses this need.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a method for designing a virtual interactive learning environment comprising reading a model defining visuospatial parameters of a simulated environment from memory and rendering the simulated environment, comprising one or more scene objects, for display within a Graphical User Interface (GUI) considering a point of view setting. The one or more scene objects comprise an interactive scene object. The method also comprises, at least once, a) defining an interactive node associated with the interactive scene object using the GUI, the interactive node defining an interactive action that, when received through the GUI, activates the interactive node, b) defining an action node associated with the interactive node using the GUI, the action node affecting a visuospatial representation of at least one of the one or more scene objects when the interactive node is activated and c) during the designing of the virtual learning environment, updating the rendered simulated environment, comprising the one or more scene objects considering the point of view setting and the action node, for display into the GUI when the action node is defined.

The method may then comprise compiling the one or more scene objects, the interactive node and the action node into the virtual learning environment and storing the virtual interactive learning environment to memory. Optionally, step c) may further comprise at least partially compiling the model, the one or more scene objects, the interactive node and the action node into the virtual learning environment for the purpose of updating the rendered simulated environment.

The method may optionally further comprise, prior to rendering the simulated environment, adding the interactive scene object into the simulated environment to define the initial visuospatial representation of the interactive scene object within the simulated environment.

Steps a), b) and c) may optionally be repeated more than once for the interactive scene object.

Optionally, steps a), b) and c) may be repeated at least once for a subsequent interactive scene object of the one or more scene objects of the simulated environment.

Optionally, the action node may define a behavior without user input comprising at least one of an animation, a display dialog, a display GUI element, a play audio behavior and a rendering effect. The animation may further indicate animation duration, position offset, rotation offset and rotation times. The dialog may further indicate dialog text, title and size. The action node and the interactive node may be set to be applied to the interactive scene object interactively rather than time-based.

Optionally, rendering the simulated environment for display may be performed in a rendering portion of the GUI and defining the interactive node and defining the action node associated with the interactive scene object may be performed in a definition portion of the GUI. The method may further comprise adding input values to each of the interactive nodes into the definition portion using the GUI. The method may yet further comprise grouping the interactive nodes and the action nodes into a first group into the definition portion of the GUI. The method may then further comprise defining a first template from the first group, wherein modifying parameters of the first template is reflected in a plurality of groups defined from the first template.

A second aspect of the present invention is directed to a non-transitory machine readable storage medium having stored thereon a computer program for designing a virtual learning environment, the computer program comprising a routine of set instructions for causing the machine to perform reading a model defining visuospatial parameters of a simulated environment from memory and rendering the simulated environment, comprising one or more scene objects, for display within a Graphical User Interface (GUI) considering a point of view setting, the one or more scene objects comprising an interactive scene object. The routine of set instructions is also for causing the machine to perform, at least once, a) defining an interactive node associated with the interactive scene object using the GUI, the interactive node defining an interactive action that, when received through the GUI, activates the interactive node, b) defining an action node associated with the interactive node using the GUI, the action node affecting a visuospatial representation of at least one of the one or more scene objects when the interactive node is activated and c) during the designing of the virtual learning environment, updating the rendered simulated environment, comprising the one or more scene objects considering the point of view setting and the action node, for display into the GUI when the action node is defined.

The routine of set instructions may also be for causing the machine to perform compiling the one or more scene objects, the interactive node and the action node into the virtual learning environment. Optionally, step c) may further comprise at least partially compiling the model, the one or more scene objects, the interactive node and the action node into the virtual learning environment for the purpose of updating the rendered simulated environment.

The routine of set instructions may further optionally comprise, prior to rendering the simulated environment, adding the interactive scene object into the simulated environment to define the initial visuospatial representation of the interactive scene object within the simulated environment.

Optionally, steps a), b) and c) may be repeated more than once for the interactive scene object. Steps a), b) and c) may also optionally be repeated at least once for a subsequent interactive scene object of the one or more scene objects of the simulated environment.

Optionally, the action node and the interactive node may be set to be applied to the interactive scene object interactively rather than time-based.

Optionally, rendering the simulated environment for display may be performed in a rendering portion of the GUI and defining the interactive node and defining the action node associated with the interactive scene object may be performed in a definition portion of the GUI.

Optionally, the routine of set instructions may further comprise adding input values to each of the interactive nodes into the definition portion using the GUI.

A third aspect of the present invention is directed to a method for designing a virtual interactive learning environment comprising i) rendering a Graphical User Interface (GUI) comprising at least a storyboarder portion and a viewport portion, ii) reading a model defining visuospatial parameters of a simulated environment, comprising one or more scene objects, from memory and iii) rendering the simulated environment, comprising the one or more scene objects, for display within the viewport portion of the GUI considering a point of view setting thereof, the one or more scene objects comprising an interactive scene object. The method also comprises iv) dragging a rendered image of the interactive scene object from the viewport portion into the storyboarder portion, wherein a corresponding node is thereby added to the storyboarder portion of the GUI, the corresponding node comprising at least one tag associated thereto and v) dragging and dropping the at least one tag, thereby causing a list of options to be displayed, the list of options comprising at least one interactive node option. The method also comprises vi) selecting an interactive node from the at least one interactive node option for vi.1) adding the interactive node to the storyboarder portion of the GUI and for vi.2) linking activation of the interactive node during execution of the virtual interactive learning environment to the rendered image of the interactive scene object as rendered during the virtual interactive learning environment.

Optionally, the method may further comprise vii) dragging and dropping at least one tag of the interactive node, thereby causing a list of options to be displayed, the list of options comprising more than one action node options and yet further comprise viii) selecting an action node from the more than one action node options for viii.1) adding the action node to the storyboarder portion of the GUI and for viii.2) affecting the rendered image of the interactive scene object when the interactive node is activated during the virtual interactive learning environment. Optionally, the steps vi) to viii) may be repeated for each additional interactive scene objects for creating the virtual interactive learning environment.

### BRIEF DESCRIPTION OF THE DRAWINGS

Further features and exemplary advantages of the present invention will become apparent from the following detailed description, taken in conjunction with the appended drawings, in which:

FIG. 1 is a logical modular representation of an exemplary system comprising a computing device for designing a virtual interactive learning environment in accordance with the teachings of the present invention;

FIG. 2 is a flow chart of an exemplary method for designing a virtual interactive learning environment in accordance with the teachings of the present invention;

FIG. 3 is a visual representation of an exemplary Graphical User Interface (GUI) showing an exemplary initial setup of the storyboarder with Begin and Setup nodes in accordance with the teachings of the present invention;

FIG. 4 is a visual representation of the storyboarder portion of an exemplary GUI showing an exemplary Scene Object added to the storyboarder in accordance with the teachings of the present invention;

FIGS. 5a, 5b, and 5c show different visual representations of an exemplary GUI showing an exemplary Click node added to the storyboarder in accordance with the teachings of the present invention;

FIG. 5d is a visual representation of an exemplary GUI showing an exemplary Animation node added to the storyboarder in accordance with the teachings of the present invention;

FIG. 6 is a visual representation of the storyboarder portion of an exemplary GUI showing an option menu in accordance with the teachings of the present invention;

FIG. 7 is a visual representation of the storyboarder portion of an exemplary GUI showing a sequence of nodes for a scenario in which a highlighted interactive scene object is clicked and animated in accordance with the teachings of the present invention;

FIG. 8 is a visual representation of the storyboarder portion of an exemplary GUI showing an exemplary sequence of nodes for a scenario in which a highlighted interactive scene object is clicked and animated and an option menu is shown in accordance with the teachings of the present invention;

FIG. 9 is a visual representation of the storyboarder portion of an exemplary GUI showing the exemplary sequence of nodes being grouped into a single node in accordance with the teachings of the present invention;

FIG. 10 is a visual representation of the storyboarder portion of an exemplary GUI showing an exemplary bolt node being nested within the grouped sequence of nodes in accordance with the teachings of the present invention;

FIG. 11 is a visual representation of the storyboarder portion of an exemplary GUI showing an exemplary bolt node being linked to the grouped sequence of nodes in accordance with the teachings of the present invention;

FIG. 12 is a visual representation of the storyboarder portion of an exemplary GUI showing the exemplary grouped sequence of nodes being copied to create a second grouped sequence of nodes in accordance with the teachings of the present invention;

FIG. 13 is a flow chart of an exemplary method for creating and publishing an exemplary interactive learning environment using a computer software; and

FIG. 14 is a exemplary flow chart of an exemplary method for designing a virtual interactive learning environment in accordance with the teachings of the present invention.

### DETAILED DESCRIPTION

In a preferred embodiment of the present invention, a virtual interactive learning environment is designed through a Graphical User Interface (GUI) in which, for example, visual elements representing physical objects can be modified upon interaction by a user (e.g., representations of hard disk drive bolts are animated when clicked). In this preferred embodiment, a Begin node and a Setup node may be added to a scene by default. In the present context, a node may be understood by a skilled person to be as a visual representation useful in the design of the virtual interactive learning environment. A Begin node defines the start of a sequence. A virtual interactive learning environment (which may also be referred to as lesson) could in theory have multiple Begin nodes. In the preferred embodiment, one Begin node and a Setup node are provided by default. A scene object or group of scene objects (e.g., a hard disk drive) may be added into the scene via the Setup node (e.g., properties of the Setup node indicate that a predefined visual model of the grouped scene objects is to be made available). The scene also comprises at least one interactive scene object, which is one of the scene object(s) from the predefined model or an additional visual model. The scene object may be understood by a skilled person to be the visual representation of one or more physical objects. An interactive scene object is a scene object accessible for interaction by the user. In addition to adding at least one interactive scene object such as the hard disk drive to the scene, the properties of the Setup node may also set the initial point of view setting, the camera setting, the lighting, and other initial parameters. The portion of the GUI where the virtual interactive learning environment is at least partially defined is referred to herein as a storyboarder. Skilled persons will readily recognize that other names could be used for the storyboarder (e.g., a visual scripter pane or definition portion of the GUI) without affecting the present invention. A visuospatial rendering of the virtual interactive learning environment, as defined by the storyboarder, is provided in a viewport portion of the GUI. In one example of a virtual learning environment designed in accordance with the teachings of the present invention, a bolt rendered in the viewport that is to be animated is dragged from its rendered position in the viewport into the storyboarder. The bolt is a scene object and interactive scene object in this example. A Click node is then added by dragging a tag of the bolt node to any location within the storyboarder and by selecting “Click node” from a list of options provided when the tag of the bolt node is released in the storyboarder. The list of options is generated based on available nodes that may be associated with the bolt node. A tag may be understood by a skilled person to be a connector that can be used to link nodes together. The Click node thereby added is referred to as an interactive node, which may be understood by a skilled person to be a specific type of node that requires a specific user input. The link between the dragged bolt and the Click node indicates that the bolt is an interactive scene object that defines a clickable area of the virtual interactive learning environment that can activate the Click node at run-time of the virtual interactive learning environment. The Click node may then be linked to the Setup node by dragging-and-dropping the nodes themselves and/or their respective tags. Linking the Click node and the Setup node may be done in order to specify that clicking the bolt is a first step of a sequence of expected actions in the virtual interactive learning environment. An Animation node is then added and linked to the Click node to allow the definition of an animation to be performed on the bolt when the interaction node is triggered (i.e., when clicked in this example). The Animation node may be understood by a skilled person to be a specific type of node that defines parameters of an animation. In one example, the bolt can be moved in the viewport to visually adjust and define the animation to be performed when clicked. For instance, by clicking a “Play” button of the GUI, a preview of the virtual interactive learning environment is provided in which the hard disk drive is shown as specified by the Setup node until the bolt is clicked, which triggers animation of the bolt as specified in the Animation node.

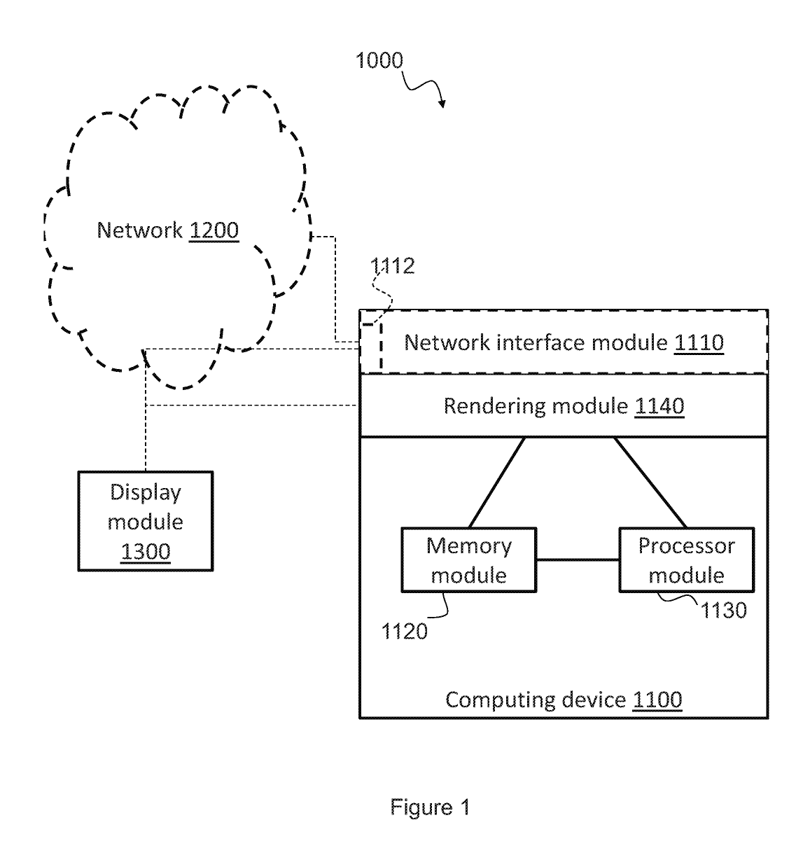

Reference is made to the drawings in which FIG. 1 shows a logical modular representation of an exemplary system 1000 comprising a computing device 1100 for designing a virtual interactive learning environment. The computing device 1100 comprises a memory module 1120, a processor module 1130 and a rendering module 1140 (which may be a dedicated module, as illustrated in the example of FIG. 1, or a sub-module of the processor module 1130). The computing device 1100 may comprise a network interface module 1110. The system 1000 also comprises a display module 1300 (e.g., connected to the computing device 1100 or integrated with the computing device 1100 (not shown)) and a network 1200 may also be used to connect to the display device and/or accessing storage or other nodes (not shown).

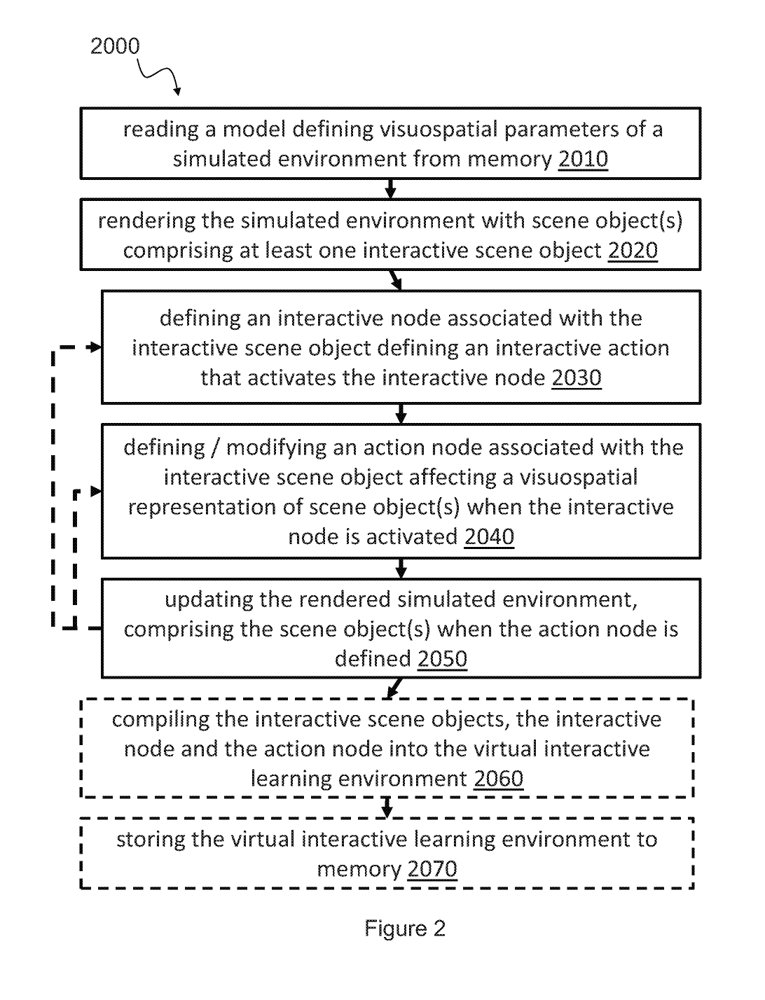

Reference is now made concurrently to FIG. 1 and FIG. 2, which shows a flow chart of an exemplary method 2000 for designing a virtual interactive learning environment comprising reading a raw model 2010 defining visuospatial parameters of a simulated environment from the memory module 1120. The simulated environment is then rendered 2020 (e.g., using the rendering module 1140) and displayed in the display module 1300. The simulated environment comprises an interactive scene object, for display within a Graphical User Interface (GUI) on the display module 1300 considering a point of view setting (e.g., in a rendering portion or viewport potion of the GUI). The simulated environment may also comprise one or more additional scene object(s), which may or may not also be additional interactive assets. Optionally, prior to rendering the simulated environment, the method 2000 may comprise adding the interactive scene object into the simulated environment to define the initial visuospatial representation of the interactive scene object within the simulated environment.

The method 2000 comprises a) defining 2030 an interactive node associated with the interactive scene object using the GUI, the interactive node defining an interactive action that, when received through the GUI, activates the interactive node. For instance, step a) 2030 may be performed by first dragging the interactive scene object depicted in the rendering portion of the GUI into a storyboarder portion (or visual scripter portion) of the GUI, thereby adding an interactive scene object tag in the storyboarder portion of the GUI. The dragging, when provided, avoids the need for the designer of the virtual interactive learning environment to necessarily provide an identifier of the dragged element and is one of the many exemplified options that allow for a more intuitive design of the virtual interactive learning environment. The interactive scene object tag may then be dragged to any location within the storyboarder portion of the GUI and one of the listed options may be selected as the interactive node for addition to the storyboarder portion of the GUI. Step a) 2030 may alternatively be performed by first dragging the interactive scene object depicted in the rendering portion of the GUI into a storyboarder portion (or visual scripter portion) of the GUI, thereby adding an interactive scene object tag in the storyboarder portion of the GUI. In this optional alternative, the interactive node may then be added by right-clicking in the storyboarder portion of the GUI, selecting one of the listed options as the interactive node for addition to the storyboarder portion of the GUI. The interactive scene object and the interactive node may then be connected either by dragging the interactive scene object tag to the interactive node or by dragging the interactive node tag to the interactive scene object in the storyboarder portion. A skilled person will understand that alternatively, the interactive node may be added before the interactive scene object.

The method 2000 also comprises b) defining 2040 an action node associated with the interactive node using the GUI. The action node may be understood by a skilled person to be a behavior node that executes without user input. In one common scenario, the action node affects the visuospatial representation of the interactive scene object itself when the associated interactive node is activated. Skilled persons will readily understand that the action node affects the visuospatial representation of one or more of the scene objects of the virtual interactive learning environment when the associated interactive node is activated. For example, a click node defined on an “electrical switch” interactive scene object may cause the visual representation of the “electrical switch” to be affected (e.g., toggled between positioned), but the click node may also affect the visuospatial representation of another scene object such as a “door” scene object operated from the switch. In one example, step b) 2040 of defining the action node may be performed by dragging the interactive scene object tag to any location within the storyboarder portion of the GUI, selecting one of the listed options as the action node for addition to the storyboarder portion of the GUI, and by moving (or otherwise affecting) (comprising the interactive scene object or not) in the rendering portion of the GUI to define the action. Alternatively, step b) 2040 may be performed by adding the action node to the storyboarder portion and dragging the scene object(s) tag (comprising the interactive scene object tag or not) to the action node in the storyboarder portion and by moving (or otherwise affecting) in the rendering portion of the GUI to define the action.

The method 2000 comprises c) updating 2050 the rendered simulated environment, comprising the interactive scene object considering the point of view setting and the action node, for display into the GUI when the action node is defined. For instance, the visual representation of the scene object(s) (comprising the interactive scene object or not) is moved (or otherwise affected) at run-time in the rendering portion of the GUI, during the design. This option, when provided, allows the designer to ascertain the action being defined, which is one more of the many exemplified options that allow for a more intuitive design of the virtual interactive learning environment. Steps a), b) and c) are performed at least once.

In the context of the exemplary method 2000, having the updating 2050 performed when the action node is defined, i.e., during the design of the virtual interactive learning environment, provides the exemplary advantage of allowing design-time ascertainment of the effect of the action node on the visuospatial representation of the scene object(s) (comprising the interactive scene object or not) at run-time of the virtual interactive learning environment. Updating 2050 the rendered simulated environment allows for a visual understanding of an intermediate state during the design of the virtual interactive learning environment. Because of the updating 2050, the designer of the virtual interactive learning environment is able to interactively, and possibly iteratively, set how the action node will affect the visuospatial representation of the scene object(s) (comprising the interactive scene object or not), if and when the associated interactive node is activated at run-time of the virtual interactive learning environment.

Steps a), b) and c), or b) and c), may optionally be repeated more than once for the interactive scene object. Additional interactive node(s) and actions node(s) may be defined based on the updated visuospatial representation of the interactive scene object (e.g., a conditional rotation followed by a conditional translation) thereby providing a chained line of conditional (or interactive event-based) actions.

Steps a), b) and c), or b) and c), may also be repeated at least once for an additional (or subsequent) interactive scene object of the simulated environment. The additional interactive scene object may be associated with the interactive scene object (e.g., two components of a single larger element) or may be independent. The different components of the larger element may also be grouped together and the larger element may be available as a grouped interactive scene object that can be treated as the interactive scene object during the design of the virtual interactive learning environment. It should be noted that the example of FIG. 2 associates the interactive node and the action node to the same interactive scene object. It is, however, possible to define different elements (e.g., an interactive node may be associated with a first interactive scene object that, when touched, activates the interactive node, which is associated with an action node of a second interactive scene object, e.g., the second element moves when the first element is clicked).

The method 2000, once design of the virtual interactive learning environment is completed or if the virtual interactive learning environment being designed is to be tested, then comprises compiling 2060 the raw model, the interactive scene object (and any optional subsequent ones), the interactive node (and any optional subsequent ones) and the action node (and any optional subsequent ones) into the virtual interactive learning environment and storing 2070 the compiled interactive learning environment to memory. For instance, the virtual interactive learning environment may be stored on a computer readable medium (not shown) and/or saved/distributed over the network 1200 (e.g., to a remote storage location, a cloud storage service, etc.). Skilled persons will note that, in some embodiments, the virtual interactive learning environment may not be compiled or not fully compiled and that all or some portions thereof may rather be interpreted at run-time.

The action node may indicate at least one of an animation, a display dialog, a display GUI element, a play audio behavior and a rendering effect. A skilled person will understand that this list is not exhaustive, and the action node may indicate other behaviors not included here. The animation may also further indicate animation duration, position offset, rotation offset and rotation time. The dialog may further indicate dialog text, title and size. The rendering effect may comprise a highlighting effect or other changes in rendering characteristics. The action node and the interactive node may be set to be applied to the (same or different) scene objects and/or interactive scene object(s) interactively (e.g., if and when a certain condition is met at run-time of the virtual interactive learning environment) rather than strictly time-based (e.g., offset time delay from the start of the virtual interactive learning environment).

The method 2000 may further comprise adding input values to each of the interactive nodes into the storyboarder portion using the GUI, grouping the interactive nodes and the action nodes into a first group into the storyboarder portion of the GUI and defining a first template from the first group. By doing so, modifying parameters of the first template is reflected in a plurality of groups defined from the first template. In the context of the groups and/or templates, a parent identifier may be defined in one or more of the child elements or child nodes to link a parent element or a parent node thereto. The parent identifier may then be used to identify the right child nodes or child elements so that one or more parameters set for the parent element or the parent node may dynamically apply to one or more child elements or child nodes. Skilled persons will understand that other solutions may be used to link parents and children (e.g., listing the children identifiers in the parent) without affecting the invention.

A non-transitory machine readable storage medium having stored thereon a computer program for designing a virtual interactive learning environment may also be provided. The computer program comprises a routine of set instructions for causing the machine to perform all or some of the steps described in relation to the above exemplary method 2000.

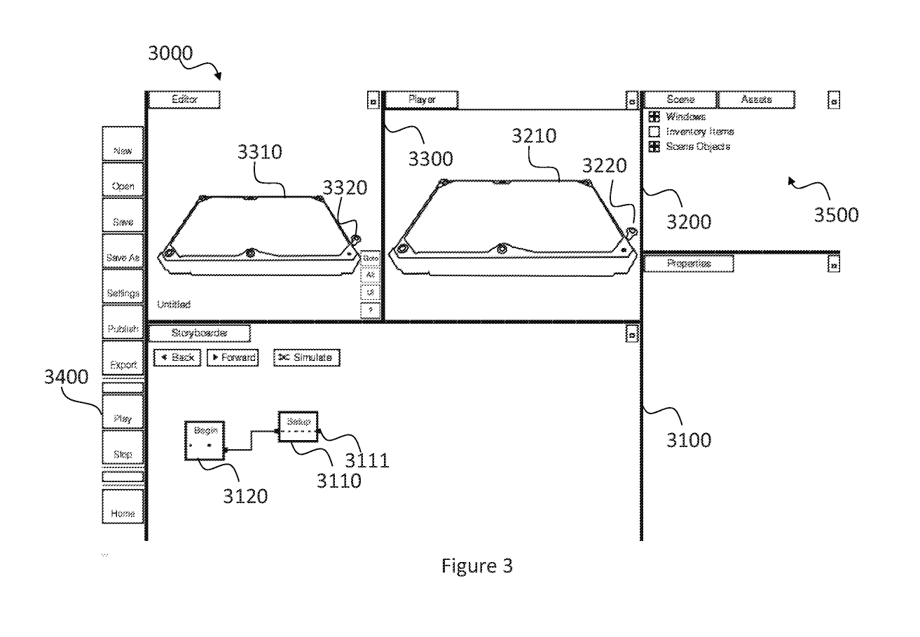

Reference is now made concurrently to FIGS. 3 to 6, which are different visual representations of an exemplary GUI 3000 in which a grouped interactive scene object 3210 (or model) is added into a scene , e.g., by the Setup node 3110. Alternatively, a model 3210 may be added into a scene, e.g., by dragging an interactive asset file from an asset pane 3500 into a viewport 3300 (or rendering portion of the GUI). The viewport 3300 is exemplified in the top left of FIG. 3 labeled “Editor”.

FIG. 3 is a visual representation of an exemplary GUI showing the initial setup of the storyboarder with Begin and Setup nodes. The “Begin” 3120 and “Setup” 3110 nodes may already be added by default. Clicking the Setup node 3110 in a storyboarder portion of the GUI 3100 after positioning the point of view in the viewport 3300 allows setting the initial position of the point of view setting, the field of view setting, the camera setting, the lighting, or the initial parameters of an interactive scene object, etc.

In the depicted example 3000, the virtual interactive learning environment will allow bolts 3220 from the depicted hard disk drive to be animated when clicked. A skilled person will readily recognize that a multitude of different scenarios involving many more items are made possible in relation to the teachings of the present invention.

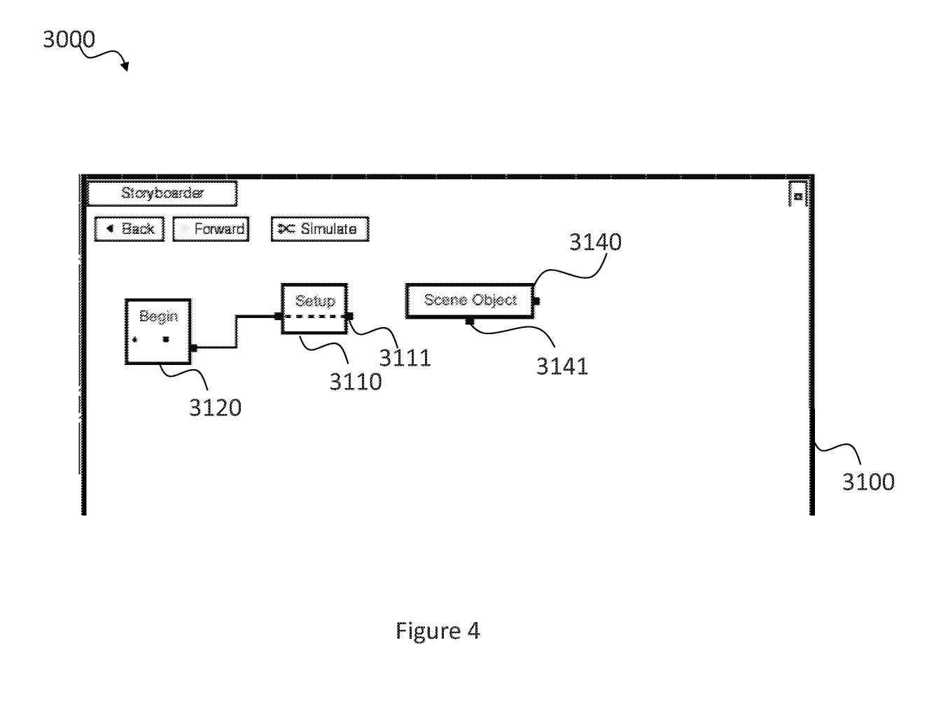

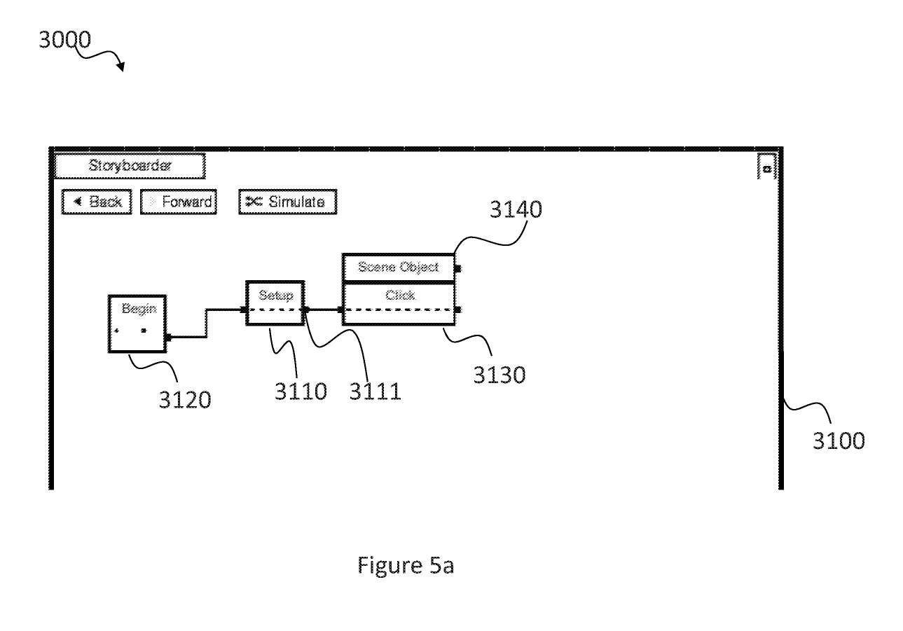

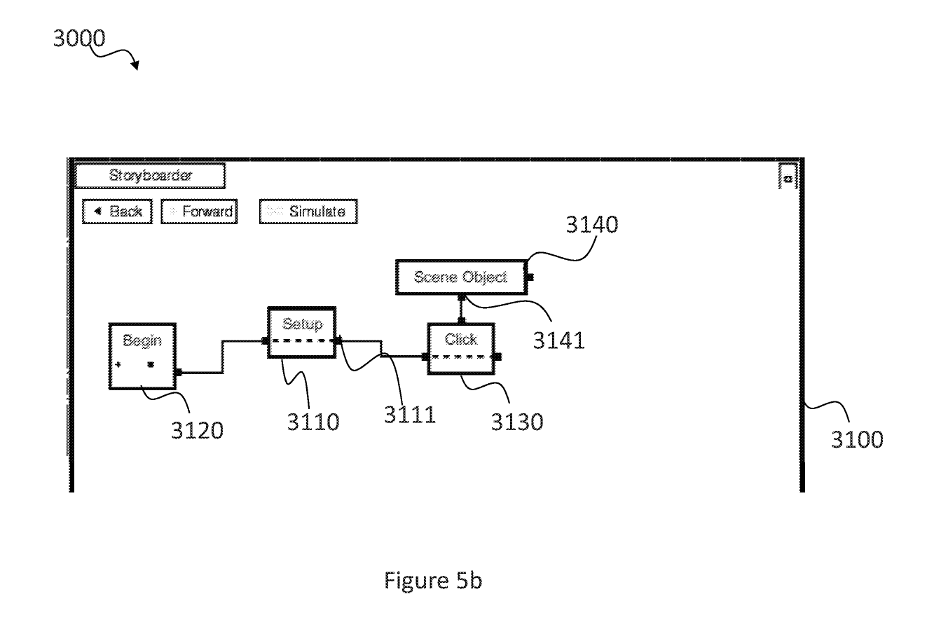

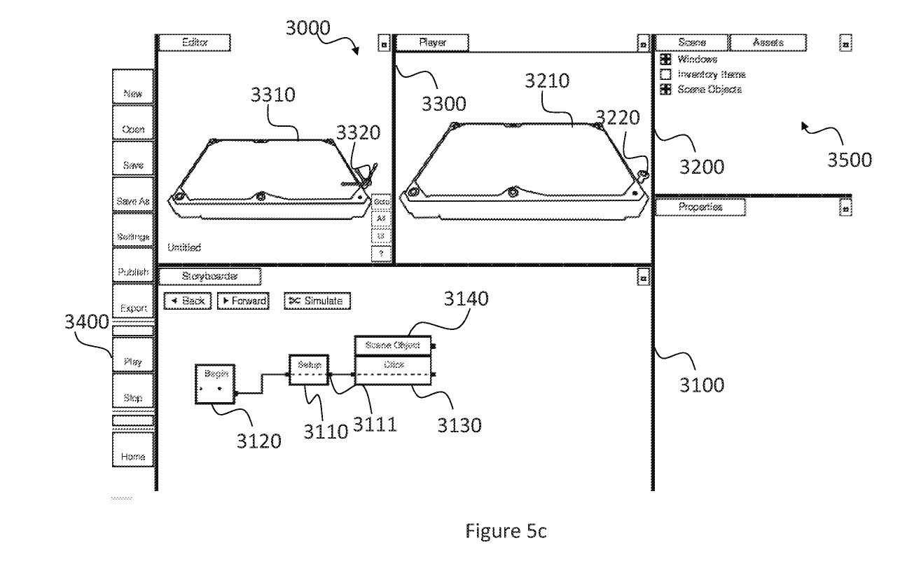

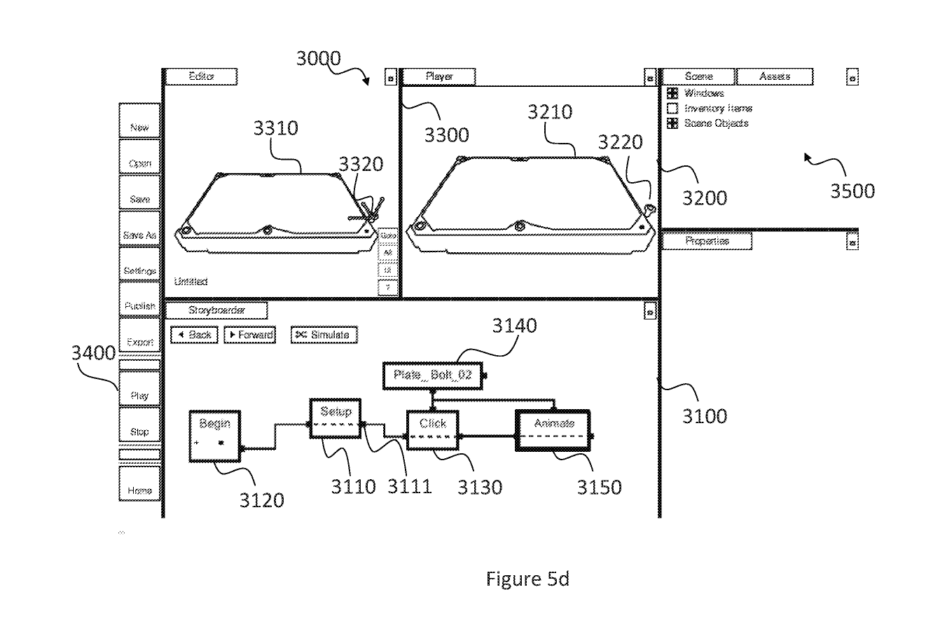

FIG. 4 is a visual representation of the storyboarder portion of an exemplary GUI showing a bolt as an example of an interactive scene object being added to the storyboarder, and FIGS. 5a, 5b, and 5c, show different visual representations of an exemplary GUI showing a Click node added to the storyboarder. The storyboarder 3100 may be used to add an interactive node such as a Click node 3130. One of the bolts 3320 (i.e., the one to be animated) may be dragged from the viewport 3300 to the storyboarder 3100. The preferred embodiment is to define an interactive scene object in the storyboarder 3100 and then to associate an interactive node with the interactive scene object. The Click node 3130 may be added by dragging the bolt node tag 3141 to any location within the storyboarder 3100 and selecting the Click node 3130 from the list of options as the interactive node. The Click node 3130 can then be linked to the Setup node 3110 by using drag-and-drop. The link between the Setup node 3110 and the Click node 3130 indicates that the Click node 3130 is the interactive node that, when activated, allows for the continuation of the scenario of the virtual interactive learning environment. The link between the bolt node 3140 and the Click node 3130 indicates that the bolt 3320 defines the clickable area, in the viewport 3300, that can activate the Click node 3130 at run-time of the virtual interactive learning environment. As an alternative, the Click node 3130 may be added by dragging the Setup node tag 3111 to any location within the storyboarder 3100 and selecting the Click node 3130 from the list of options as the interactive node. As a further alternative, the Click node 3130 may be added by right-clicking in the storyboarder 3100 and selecting the Click node 3130 from the list of options as the interactive node. It should be noted that the scenario does not need to be linear and that many different nodes (not shown) may provide for its continuation, e.g., via multiple paths.

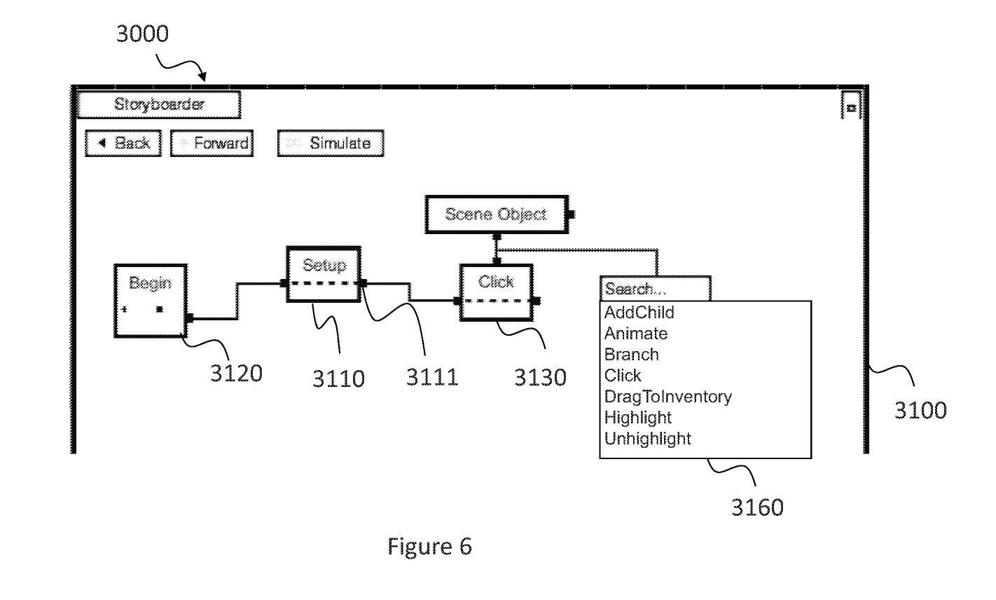

FIG. 5d is a visual representation of an exemplary GUI showing an Animation node as an example of an action node being added to the storyboarder 3100. An Animation node 3150 may be added and linked to the Click node 3130 (as depicted in FIGS. 5d and 6). In the depicted example, the Animation node 3150 is the action node triggered by the Click node 3130. The preferred embodiment is to define a scene object in the storyboarder and then to associate an action node with the scene object. Adding the Animation node 3150 may be performed by dragging the bolt node tag 3141 to any location within the storyboarder 3100 and selecting one of the listed options 3160 as the Animation node 3150 for addition to the storyboarder 3100. The Animation node 3150 may then be hooked to the Click node 3130. As an alternative, the Animation node 3150 may be added by right-clicking in the storyboarder 3100. The Animation node 3150 may then be hooked to the bolt node 3140 and the Click node 3130. Once the Animation node 3150 is selected in the storyboarder 3100, the bolt 3320 can be moved in the viewport 3300 to visually adjust the animation of the Animation node 3150. Rendering in the viewport 3300 is performed while the animation is being defined to allow the user to ascertain or visualize and properly set the desired animation.

At this point, a first step in the example is already defined. Clicking the “Play” button 3400 (e.g., depicted on the left) will provide a preview of the virtual interactive learning environment. The virtual interactive learning environment will wait for the user to click on the bolt 3220 and then animate it as specified.

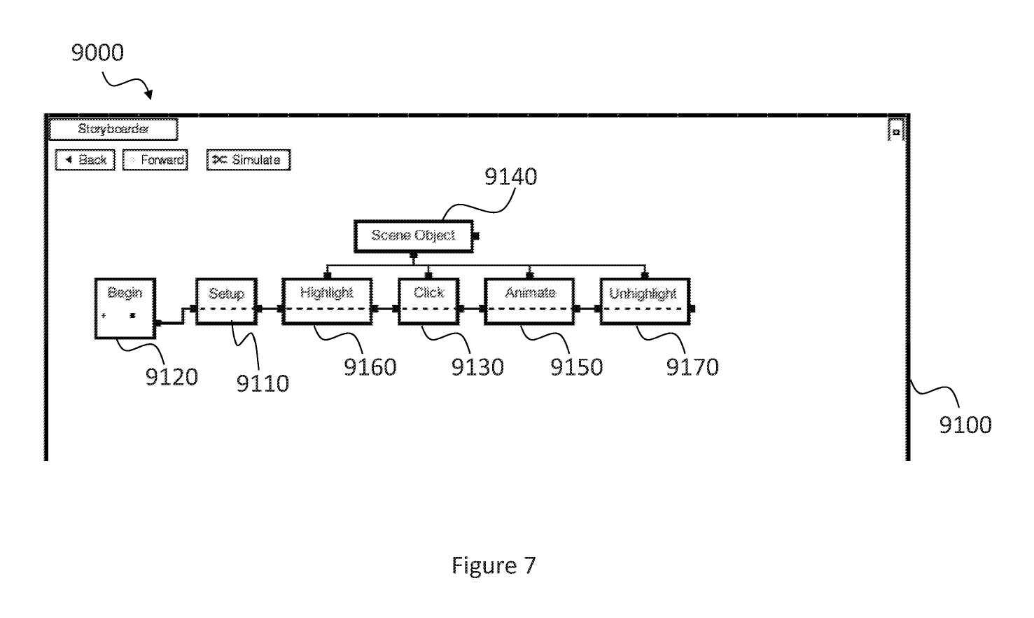

Reference is now made concurrently to FIGS. 7 to 12, which are different visual representations of an exemplary GUI 9000 in which the expected scenario is to highlight, animate and then un-highlight an interactive scene object once clicked. For instance, this may be performed on a bolt as the exemplary interactive scene object. The bolt is first highlighted (via a Highlight node 9160) after adjustment of the Setup node 9110 (as exemplified in 3000). A Click node 9130 and an Animate node 9150, similar to the ones of the example 3000 are also added after the Highlight node 9160. The Click node 9130 instructs, at run-time of the virtual interactive learning environment, for the bolt to be animated. A Drag to Parts Tray node may be added (not shown), that may wait, at run-time of the virtual interactive learning environment, for the bolt to be dragged to a displayed parts tray, thereby removing the bolt. A Unhighlight node 9170 may further be added to the sequence.

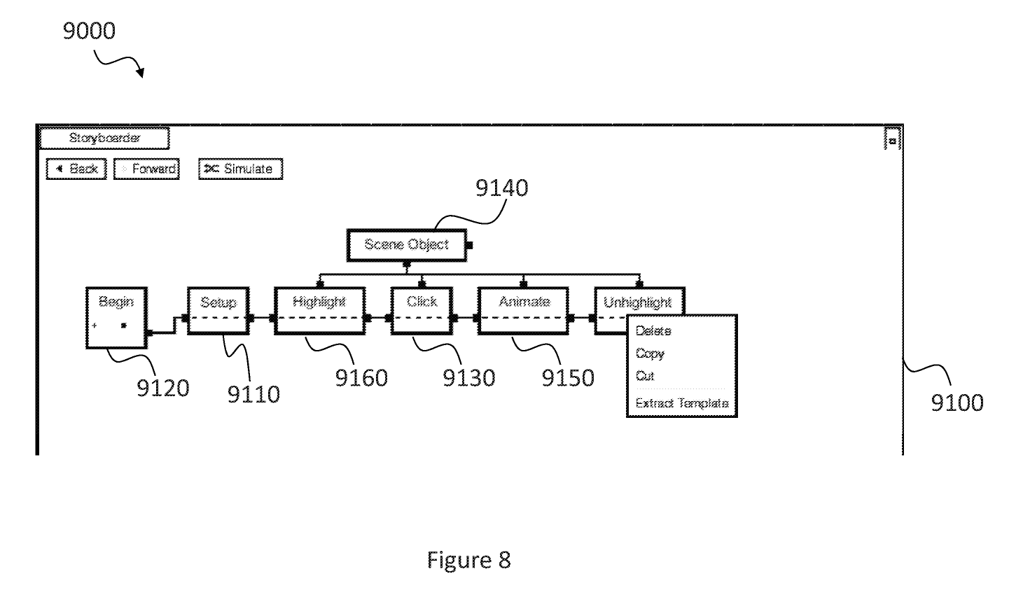

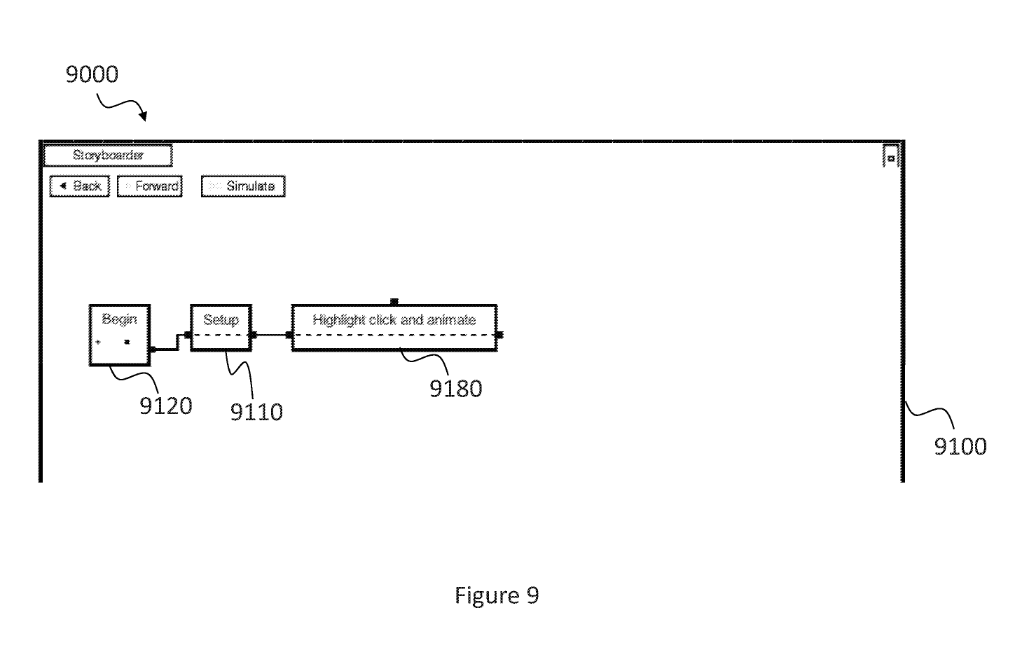

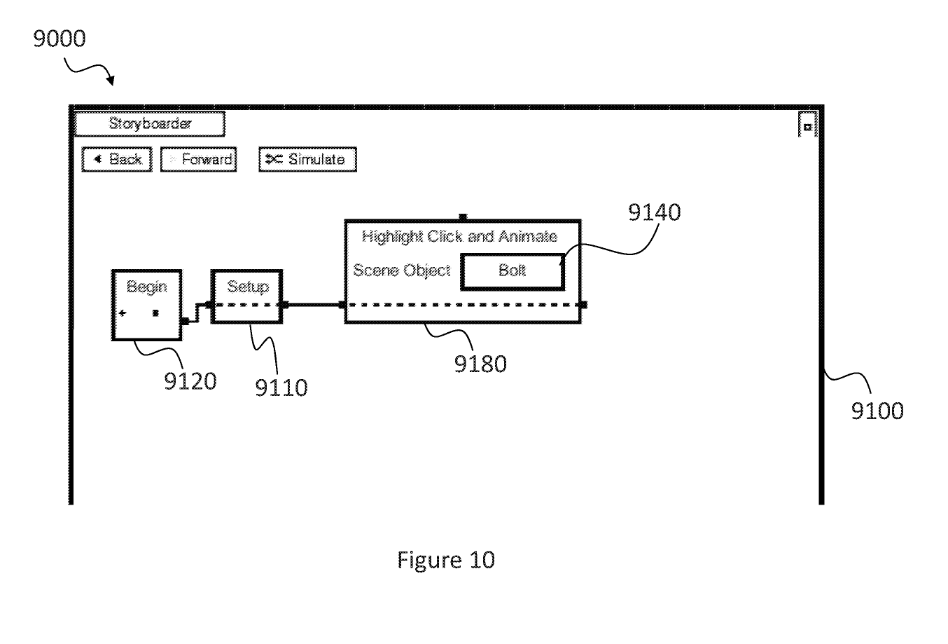

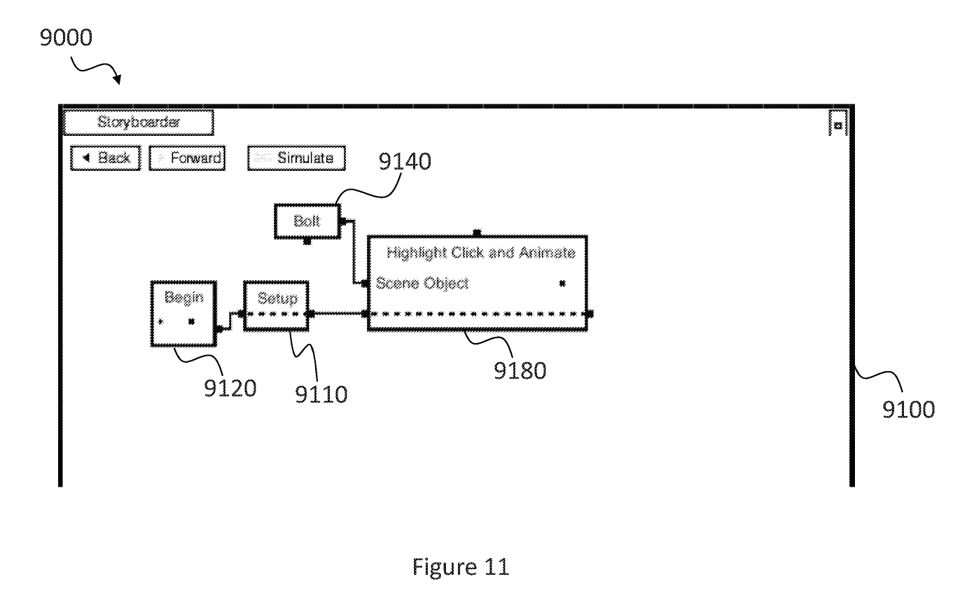

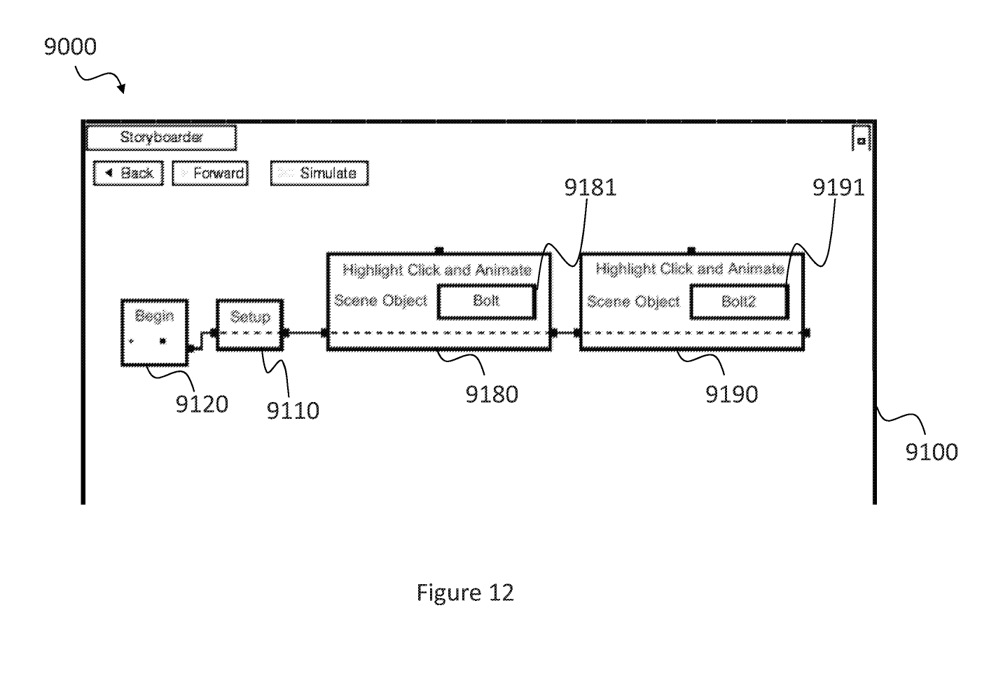

FIG. 8 is a visual representation of the storyboarder portion of an exemplary GUI showing a sequence of nodes for a scenario in which the highlighted exemplary bolt is clicked and animated (e.g., it could further be removed to a parts tray). FIG. 9 is a visual representation of the storyboarder portion of an exemplary GUI showing the sequence of nodes being grouped into a single node. By selecting the nodes of example 9000 (e.g., all nodes except Begin 9120 and Setup 9110 in the depicted example), it is possible to group them and, if desired, to provide a name to the group. While not depicted, skilled persons will readily understand that the Begin 9120 and Setup 9110 nodes could also be part of a group. FIG. 11 is a visual representation of the storyboarder portion of an exemplary GUI showing the exemplary bolt node 9140 being added and linked to the group 9180. Alternatively, FIG. 10 is a visual representation of the storyboarder portion of an exemplary GUI showing a bolt node 9181 being added as a nested node within the group 9180. FIG. 12 is a visual representation of the storyboarder portion of an exemplary GUI showing how the group may then be copied and another interactive scene object (such as another bolt) can be dragged from the viewport and hooked to the second group 9190. In the example 9000, it is possible to double click on the created group 9180 and change its behavior. The two groups 9180 and 9190 can be changed independently. The group 9180 may also be converted into a template, which would allow a change to be done once for every group derived therefrom.

At run-time of the virtual interactive learning environment, in the depicted example, the two bolts 9181 and 9191 are expected to be clicked in the specified order. However, it is possible to design the virtual interactive learning environment to allow the bolts 9181 and 9191 to be clicked in any order. For instance, executing multiple Click/Animate nodes (or other actions) in parallel may be performed by using a Fork node to spawn multiple threads of execution, and then using a Wait node to wait for all the threads to complete before continuing. A For Each Item node may also be used to specify a list such that instead of executing the given operation sequentially for each element, it executes the given operation for each element in the list all at once (and then waits for all operations to finish before continuing).

Another way of representing the example 9000 is to group the bolts into a list of items and hook the list to a loop node (such as a For Each Item node) that applies a selected action to each item of the hooked list. Adding a new bolt to the list will allow the same action to be available thereto.

Different basic nodes may be provided for minimizing the design time. For instances, the basic nodes may include:

Scene Object Node (interactive asset node):
Represents a rendered object in the scene.
Exposes the following properties for use by other nodes: Position, rotation, visibility and parent transform.
Exposes the following actions (described below): Highlight, Animation Custom, Animate, Animate Sequence.
Exposes the following interactions (described below): Click, DragTolnventory, DragOnAxis.

Inventory Item Node (interactive asset node):
Represents an inventory UI item that exists in one of the inventory UI windows.
Exposes the following properties for use by other nodes:
   Count—The number of instances of this item in the inventory. Once this reaches zero, the item is no longer visible.
   Order—A number representing where in the inventory to display the item.
Exposes the following interactions (described below): Click With, Drag To Scene

Drag To Scene:
When executed, the simulation waits until the user drags the inventory UI element and drops it on a 3D object in the scene, at which point the object becomes visible if it wasn't already.
Inputs:
   Model—The 3D object in the scene to make visible after drag and drop occurs.
   Highlight Color—The color to use to highlight the 3D object

Click With:
When executed, the simulation waits until the user clicks on the inventory UI element, then waits until the user clicks on the given 3D object in the scene.
Inputs:
   Model—The 3D object in the scene for the user to click on with the given UI element.

Animation Node:

Inputs: Duration, position offset, rotation offset, rotation multiplier, and interpolation type.

When executed, the attached scene object is translated and rotated over the given offsets over the given time interval using the given interpolation type.

Offsets can be changed directly using a three dimensional tool (e.g., referred to as a gizmo) that defines the translation and/or rotation of an interactive scene object in the viewport.

Drag To Inventory Node:
When executed, the simulation waits until the user drags the given scene object out of the 3D scene and drops it on to a 2D UI element, at which point the given part appears listed in the parts tray and the 3D object becomes invisible.
Inputs:
   Inventory item—2D icon for object being removed from the scene.
   Inventory—2D window to place the icon.
The reverse operation, Drag From Parts Tray, may also be available.

Drag on Axis Node:

Inputs: Offset position and offset rotation.

When executed, the simulation waits until the user drags the attached scene object from its starting position to the end position, which is calculated using the given offset values. This procedure can optionally require that the user have a tool enabled.

Click Node:

When executed, the simulation waits until the given scene object is clicked. A specific mouse button may also further be defined.

Display Dialog Node:

Inputs: Title, message.

When executed, displays a pop-up dialog that displays the given information. The simulation proceeds once the user presses a button in the dialog.

Play Audio Node:

Takes an audio asset node as input and plays the file associated with it when executed.

Branch Node:

Takes any value as input and executes one of several different sequences of nodes depending on the value. This can result in different nodes being executed depending on a runtime value and can be used to make non-linear lessons.

Inputs:
Condition Value—The value used to determine which sequence of nodes to execute.
Value and Node sequence pair—The sequence of nodes to execute when the condition value is equal to the given value. There may be multiple pairs attached to the branch node to address many different variations on the value.

Fork Node:
Allows user to spawn any number of threads to execute multiple different sequences of nodes at once. To do this the user can add rows to the Fork node and connect different sequences of nodes they wish to execute. The Fork node also includes an optional flag that determines whether to wait until all threads are fully complete before continuing on to the next node.
Inputs:
   Sequence of nodes—A sequence of nodes to execute.

Delay Node:

Inputs: Time—The amount of time to wait before proceeding to the next node.

When executed, the executing thread is paused until the given number of seconds has elapsed.

Setup Node:
This node can be used to change the state of any objects in the scene. At design-time, the user can add any number of scene objects to this node (e.g., cameras, models, lights) and then by selecting the rows within the node that correspond to those objects, can change the values of any properties of the given object. This can be used to set models to specific positions/rotations, adjust camera view points, load models, and customize UI elements.
Inputs:
   Time—By default (if time is zero), when the setup node is executed it will immediately trigger all the state changes that have been associated with it. Alternatively, the setup node can interpolate towards the given target values over a given time interval. Note that this interpolation would only apply to numeric values and not discrete values such as text changes or boolean flags.

Decorator Node:
This is a special class of node that can be used to execute a behavior immediately before or immediately after another node has executed. It is special in that it is rendered to be much smaller than other nodes and does not have links and instead connects directly to the tags of other nodes. This is used to execute logging, profiling, user data tracking, as well as general purpose debugging.

Type Node:
This node represents a reference to a type. This type could be a built-in primitive type such as integer, float, or Vector3, but could also be a user-defined type.
Inputs:
   Sub-types. Some types such as List require one or more sub-types defined. In the case of List this would represent the element type. In most cases this will be empty.

Local Variable Node:
This node is used to store information in memory.
Inputs:
   Type—A reference to a type node may be required, to define what kind of data the variable represents.

Loop Node:
This node will execute the given sequence of nodes to completion, then continue to repeat the same set of nodes indefinitely or until an End Loop node is reached.
Inputs:
   Sequence of nodes to loop over.

End Loop Node:
When executed inside a Loop node, this will cause execution to immediately jump to the next node following the Loop node.
Inputs: None.

Arithmetic Node:

Inputs: Two numeric values and an operation type which could include one of the following: Add, subtract, multiply, divide, modulo.

Output: The result of the given operation applied to the given values.

Comparison Node:

Inputs: Two value references and a comparison type which could include one of: Equals, greater than, greater than or equal, less than, less than or equal, and not equal.

Output: The result of the given operation applied to the given values.

Logic Node:

Inputs: Two Boolean values, and an operation type which could include one of the following: Or, And, Exclusive Or.

Output: The result of the given operation applied to the given values.

Lerp Node:

Inputs: Two values which can be one of the following types: Number, Vector, or Quaternion. It also takes as input a decimal value to indicate percentage.

When executed, performs a linear interpolation between the two arguments using the given percentage value.

Audio Asset Node:

Represents an audio file. Exposes properties of the audio file such as length.

DoesListContain Node:

Inputs: A list of values as well as a single value.

When executed, performs a search through the list and outputs a boolean value for whether the list contains the given object.

Yield Node:

When executed, delays execution until the next frame before proceeding with the subsequent node. This can be used in tight loops to ensure that the simulation maintains a consistent render frame rate.

Continue Loop Node:
When executed inside a Loop node, this will cause execution to immediately jump to the next iteration of the loop.

Highlight Node:

Inputs: a scene object and static parameters for highlight type and color.

When executed, applies the given highlight parameters to the given scene object.

If Node:

Inputs: Boolean condition value.

When executed, the given condition is evaluated. If the result is true the simulation continues down the first connected output, and otherwise continues down the second output.

Mouse Node:

Exposes the following properties for use by other nodes: Mouse position, mouse left button state, mouse right button state, mouse middle button state.

Part Node:

Exposes the following properties for use by other nodes: Part image, part count.

Wait Node:

Inputs: Any number of execution threads.

This node may be used in conjunction with the Fork node.

When executed, execution is halted until all input threads are fully complete. This allows the user to execute any number of operations in parallel, and then wait until all operations are complete before continuing to the next node.

For Each Item Node:

Inputs: List of values and an action to perform.

When executed, the given action is executed (sequentially or in parallel) for each element in the given list.

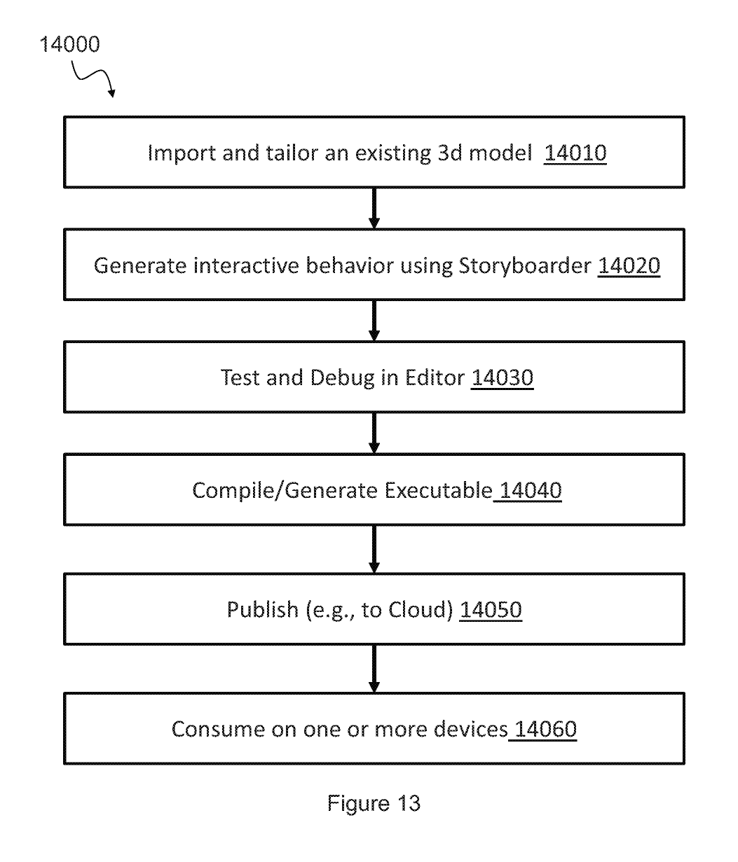

FIG. 13 presents a flow chart of an exemplary method 14000 for creating and publishing a virtual interactive learning environment using a computer software. A 3D model or representation of an object or group of objects (e.g., created using a specialized software or system) is imported 14010 and may also be tailored in the computer software (e.g., adjusting pivot points, re-positioning transforms, and possibly changing colors/textures/shaders, etc.) into the virtual interactive learning environment. A virtual interactive learning environment is then designed 14020 from the 3D model (see the examples of FIGS. 2 and 3 to 6 and 7 to 12). Testing and Debugging 14030 may then be performed before compiling and/or generating an executable 14040 of the designed virtual interactive learning environment (e.g., finding errors in the storyboarder by stepping through the virtual interactive learning environment one node at a time, for example, and inspecting different run-time values).The compiled virtual interactive learning environment or executable virtual interactive learning environment is then published 14050 (e.g., to a cloud storage). Multiple devices (e.g., based on distributed credentials) can then receive or access the virtual interactive learning environment for its intended purpose. For instance, the user can choose to publish their virtual interactive learning environment as “public” (in which case it is viewable by anyone and does not require special credentials) or “private” (in which case the user has to be granted explicit permission by the lesson author to view). Proprietary or custom distribution schemes may also be used.

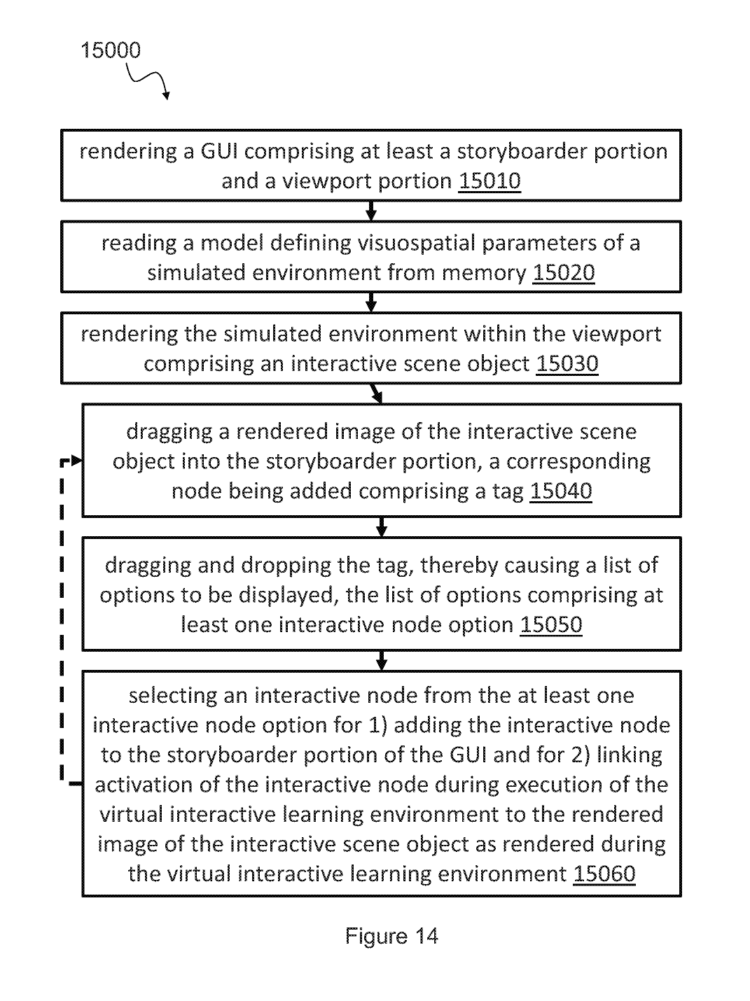

FIG. 14 shows a flow chart of an exemplary method 15000 for designing a virtual interactive learning environment in accordance with the teachings of the present invention. The method 15000 comprises rendering 15010 a Graphical User Interface (GUI) comprising at least a storyboarder portion and a viewport portion. The method 15000 also comprises reading 15020 a model defining visuospatial parameters of a simulated environment, comprising one or more scene objects, from memory and rendering 15030 the simulated environment, comprising the one or more scene objects, for display within the viewport portion of the GUI considering a point of view setting thereof, the one or more scene objects comprising an interactive scene object. The method 15000 also comprises iv) dragging 15040 a rendered image of the interactive scene object from the viewport portion into the storyboarder portion, wherein a corresponding node is thereby added to the storyboarder portion of the GUI, the corresponding node comprising at least one tag associated thereto and v) dragging and dropping 15050 the at least one tag, thereby causing a list of options to be displayed, the list of options comprising at least one interactive node option. The list of options shown in v) 15050 is generated from the perspective of the scene object from which the tag was selected. The list of options shown in v) 15050 may comprise only interaction node options (e.g., based on the fact that no other interaction node has previously been associated to the interactive scene object), but may also comprise other options including action node options (e.g., the action node being applied to the interactive scene object at that point in the virtual interactive learning environment without interaction). The method also comprises vi) selecting 15060 an interactive node from the at least one interactive node option for vi.1) adding the interactive node to the storyboarder portion of the GUI and for vi.2) linking activation of the interactive node during execution of the virtual interactive learning environment to the rendered image of the interactive scene object as rendered during the virtual interactive learning environment.

The interactive node may further be linked manually (via lateral tags thereof) or automatically (e.g., based on the sequencing of the addition) to a Setup node, e.g., for managing the sequencing of the virtual interactive learning environment.

Optionally, the method 15000 may further comprise vii) dragging and dropping the tag of the interactive scene object (i.e., the same tag as in as in 15050), thereby causing the list of options to be displayed, the list of options comprising more than one action node options. The list of options shown in vii) is generated from the perspective of the scene object from which the tag was selected. The list of options shown in vii) may be the same as the list of options shown following v) 15050 (thereby also allowing more than one interactive node to be daisy-chained). In another example, the list of options in vii) may be limited to action node options based on the fact that the interactive scene object has already been associated to an interactive node in vi) 15060.

The method 15000 may also further comprise viii) selecting an action node from the more than one action node options for viii.1) adding the action node to the storyboarder portion of the GUI and for viii.2) affecting the rendered image of the interactive scene object when the interactive node is activated during the virtual interactive learning environment. In one embodiment, the action node is linked to the previously added interactive node by dragging and dropping a lateral tag of one of the two nodes towards the other one. The link may also be done or suggested to the designer (e.g., based on the sequence of nodes being added to the storyboarder portion and/or based on the proximity of the “drop” action compared to a position of the node(s) depicted in the storyboarder portion). In another embodiment, the step vii) dragging and dropping may also be performed on a tag of the interactive node instead of the interactive scene object, in which a link to the interactive scene object may then need to be otherwise provided to complete the association of the interactive scene object with the interaction node and the action node.

Optionally, the steps vi) 15040 to viii) 15060 may be repeated for each additional interactive scene objects for creating the virtual interactive learning environment.

The processor module 1130 may represent a single processor with one or more processor cores or an array of processors, each comprising one or more processor cores. The memory module 1120 may comprise various types of memory (different standardized or kinds of Random Access Memory (RAM) modules, memory cards, Read-Only Memory (ROM) modules, programmable ROM, etc.). Storage devices module (not shown) may represent one or more logical or physical as well as local or remote hard disk drive (HDD) (or an array thereof). The storage devices module may further represent a local or remote database made accessible to the computing device 1100 by a standardized or proprietary interface. The network interface module 1110 may represent at least one physical interface that can be used to communicate with other network nodes. The network interface module 1110 may be made visible to the other modules of the computing device 1100 through one or more logical interfaces. The actual stacks of protocols used by the physical network interface(s) and/or logical network interface(s) of the network interface module 840 do not affect the teachings of the present invention. The variants of processor module 1130, memory module 1120, network interface module 1110 and storage devices module usable in the context of the present invention will be readily apparent to persons skilled in the art. Likewise, even though explicit mentions of the memory module 1120, rendering module 1140 and/or the processor module 1130 are not made throughout the description of the present examples, persons skilled in the art will readily recognize that such modules are used in conjunction with other modules of the computing device 1100 to perform routine as well as innovative steps related to the present invention.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further passe through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for designing a virtual interactive learning environment comprising:
reading a model defining visuospatial parameters of a simulated environment from memory;
rendering the simulated environment, comprising one or more scene objects, for display within a Graphical User Interface (GUI) considering a point of view setting, the one or more scene objects comprising an interactive scene object; and
at least once:
a) defining an interactive node associated with the interactive scene object using the GUI, the interactive node defining an interactive action that, when received through the GUI, activates the interactive node;
b) defining an action node associated with the interactive scene object using the GUI, the action node affecting a visuospatial representation of at least one of the one or more scene objects when the interactive node is activated; and
c) during the designing of the virtual learning environment, updating the rendered simulated environment, comprising the one or more scene objects considering the point of view setting and the action node, for display into the GUI when the action node is defined.

2. The method of claim 1, further comprising compiling the one or more scene objects, the interactive node and the action node into the virtual learning environment and storing the virtual interactive learning environment to memory, wherein c) further comprises at least partially compiling the one or more scene objects, the interactive node and the action node into the virtual learning environment for the purpose of updating the rendered simulated environment.

3. The method of claim 1 further comprising, prior to rendering the simulated environment, adding the interactive scene object into the simulated environment to define the initial visuospatial representation of the interactive scene object within the simulated environment.

4. The method of claim 1, wherein a), b) and c) are repeated more than once for the interactive scene object.

5. The method of claim 4, wherein a), b) and c) are repeated at least once for a subsequent interactive scene object of the one or more scene objects of the simulated environment.

6. The method of claim 1, wherein the action node defines a behavior without user input comprising at least one of an animation, a display dialog, a display GUI element, a play audio behavior and a rendering effect.

7. The method of claim 6, wherein the animation further indicates animation duration, position offset, rotation offset and rotation times.

8. The method of claim 6, wherein the action node and the interactive node are set to be applied to the interactive scene object interactively rather than time-based.

9. The method of claim 5, wherein rendering the simulated environment for display is performed in a rendering portion of the GUI and wherein defining the interactive node and defining the action node associated with the interactive scene object are performed in a definition portion of the GUI.

10. The method of claim 9, further comprising adding input values to each of the interactive nodes into the definition portion using the GUI.

11. The method of claim 10, further comprising grouping the interactive nodes and the action nodes into a first group into the definition portion of the GUI.

12. The method of claim 11, further comprising defining a first template from the first group, wherein modifying parameters of the first template is reflected in a plurality of groups defined from the first template.

13. A non-transitory machine readable storage medium having stored thereon a computer program for designing a virtual learning environment, the computer program comprising a routine of set instructions for causing the machine to perform:
reading a model defining visuospatial parameters of a simulated environment from memory;
rendering the simulated environment, comprising one or more scene objects, for display within a Graphical User Interface (GUI) considering a point of view setting, the one or more scene objects comprising an interactive scene object; and
at least once:
a) defining an interactive node associated with the interactive scene object using the GUI, the interactive node defining an interactive action that, when received through the GUI, activates the interactive node;
b) defining an action node associated with the interactive node using the GUI, the action node affecting a visuospatial representation of at least one of the one or more scene objects when the interactive node is activated; and
c) during the designing of the virtual learning environment, updating the rendered simulated environment, comprising the one or more scene objects considering the point of view setting and the action node, for display into the GUI when the action node is defined.

14. The storage medium of claim 13, wherein the routine of set instructions further comprises compiling the one or more scene objects, the interactive node and the action node into the virtual learning environment and wherein c) further comprises at least partially compiling, the one or more scene objects, the interactive node and the action node into the virtual learning environment for the purpose of updating the rendered simulated environment.

15. The storage medium of claim 13, wherein the routine of set instructions further comprises, prior to rendering the simulated environment, adding the interactive scene object into the simulated environment to define the initial visuospatial representation of the interactive scene object within the simulated environment.

16. The storage medium of claim 13, wherein a), b) and c) are repeated more than once for the interactive scene object.

17. The storage medium of claim 16, wherein a), b) and c) are repeated at least once for a subsequent interactive scene object of the one or more scene objects of the simulated environment.

18. The storage medium of claim 13, wherein the action node and the interactive node are set to be applied to the interactive scene object interactively rather than time-based.

19. The storage medium of claim 17, wherein rendering the simulated environment for display is performed in a rendering portion of the GUI and wherein defining the interactive node and defining the action node associated with the interactive scene object are performed in a definition portion of the GUI.

20. The storage medium of claim 19, wherein the routine of set instructions further comprises adding input values to each of the interactive nodes into the definition portion using the GUI.

21. A method for designing a virtual interactive learning environment comprising:
i) rendering a Graphical User Interface (GUI) comprising at least a storyboarder portion and a viewport portion;
ii) reading a model defining visuospatial parameters of a simulated environment, comprising one or more scene objects, from memory;
iii) rendering the simulated environment, comprising the one or more scene objects, for display within the viewport portion of the GUI considering a point of view setting thereof, the one or more scene objects comprising an interactive scene object;
iv) dragging a rendered image of the interactive scene object from the viewport portion into the storyboarder portion, wherein a corresponding node is thereby added to the storyboarder portion of the GUI, the corresponding node comprising at least one tag associated thereto;
v) dragging and dropping the at least one tag, thereby causing a list of options to be displayed, the list of options comprising at least one interactive node option; and
vi) selecting an interactive node from the at least one interactive node option for:
vi.1) adding the interactive node to the storyboarder portion of the GUI; and
vi.2) linking activation of the interactive node during execution of the virtual interactive learning environment to the rendered image of the interactive scene object as rendered during the virtual interactive learning environment.

22. The method of claim 21, further comprising vii) dragging and dropping the at least one tag, thereby causing the list of options to be displayed, the list of options comprising more than one action node options.

23. The method of claim 22, further comprising viii) selecting an action node from the more than one action node options for:
viii.1) adding the action node to the storyboarder portion of the GUI; and
viii.2) affecting the rendered image of the interactive scene object when the interactive node is activated during the virtual interactive learning environment.

24. The method of claim 23, wherein steps vi) to viii) are repeated for each additional interactive scene objects for creating the virtual interactive learning environment.

25. The method of claim 21 further comprising compiling the model, the one or more scene objects, the interactive node and the action node into the virtual learning environment and storing the virtual interactive learning environment to memory.
